(19) United States
(12) Patent Application Publication
(10) Pub. No.: US 2006/0064877 A1
(43) Pub. Date: Mar. 30, 2006

(54) Folding knife

(75) Inventors: Alney K Vallotton, Oakland, OR (US); Edgar A Dallas, Beaverton, OR (US)

Correspondence Address: FOLEY & LARDNER LLP, 777 EAST WISCONSIN AVENUE, SUITE 3800, MILWAUKEE, WI, 53202-5308, US

(73) Assignee: FISKARS BRANDS, INC., Madison, WI (US)

(21) Appl. No.: 10/530,958

(22) PCT Filed: Oct. 7, 2003
(86) PCT No.: PCT/US03/31745

§ 371 Date: Apr. 8, 2005

Related U.S. Application Data
(60) Provisional application No. 60/416,830, filed on Oct. 8, 2002.

(51) Int. Cl. B26B 3/06; F41B 13/02

(52) U.S. Cl. 30/153; 30/155

(57) ABSTRACT

A folding tool includes a handle and an implement pivotally coupled to the handle according to one embodiment. The implement is adapted to travel between a closed position and an open position and has a tang with a contoured surface. A spring arm has a first end coupled to the handle and a second end adapted to interact with the implement. The spring arm exerts an opening force on the implement during at least a portion of the travel of the implement between the closed position and the open position and also locks the implement into the open position.

### CROSS-REFERENCE TO RELATED APPLICATIONS

This application claims the benefit of U.S. Provisional Application No. 60/416,830, filed Oct. 8, 2002, which is incorporated herein by reference in its entirety.

### FIELD OF THE INVENTION

The present invention relates to a folding knife. In particular, the present invention relates to a folding knife having a mechanism used to assist the user in opening the knife.

### BACKGROUND OF THE INVENTION

Folding knives typically include a handle and one or more blades pivotally attached to the handle, the blades having a compact closed position and an extended open position. A user opens the blade by grasping the blade or pushing a knob protruding from the blade in order to rotate the blade into the open position.

Additional features are added to folding knives in order to make such knives more useful and easier to operate. Such features may include a mechanism used to assist the user in opening the knife, a mechanism used to lock the blade into an open position, and a mechanism to bias the blade into the closed position. Adding additional features increases the cost and complexity of the folding knife. Cost considerations may outweigh the desire for additional features for folding knives that are intended for sale at moderate prices. Accordingly, there is a need for a mechanism that provides additional features that does not unacceptably raise manufacturing costs. Further, there is a need for such a mechanism that performs multiple desired functions using the same parts.

The components required to effectuate features such as an assisted opening function or a blade lock function utilize space in a folding knife that may otherwise be used for other purposes. Accordingly, there is need for a simplified mechanism that provides desirable features but does not utilize a great deal of space within a knife handle.

It would be desirable to provide a folding knife that includes a mechanism that provides one or more of these or other advantageous features. Other features and advantages will be made apparent from the present specification. The teachings disclosed extend to those embodiments that fall within the scope of the appended claims, regardless of whether they accomplish one or more of the aforementioned needs.

### SUMMARY OF THE INVENTION

The invention relates to a folding tool having a handle and an implement pivotally coupled to the handle. The implement is adapted to travel between a closed position and an open position and includes a tang with a contoured surface. A spring arm has a first end coupled to the handle and a second end adapted to interact with the implement. The spring arm both exerts an opening force on the implement during at least a portion of the implement's travel between the closed position and the open position and locks the implement into the open position.

The invention further relates to a folding knife having a handle and a blade pivotally coupled to the handle. The blade has a closed position and an open position and includes a tang with a contoured surface. The folding knife further includes a spring located in a plane defined by the blade, the spring having a proximal end coupled to the handle and a distal end adapted to exert a force on the blade via contact with the contoured surface.

The invention is capable of other embodiments and of being practiced or carried out in various ways. Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a front elevation view of folding knife with the blade in the open position;

FIG. 2 is an exploded view of a folding knife according to an exemplary embodiment;

FIG. 3 is a cut-away front elevation view of a folding knife with the blade in the closed position;

FIG. 4 is a cut-away front elevation view of a folding knife with the blade in a partially opened position;

FIG. 5 is a cut-away front elevation view of a folding knife with the blade in a partially opened position;

FIG. 6 is a cut-away front elevation view of a folding knife with the blade in a fully opened and locked position;

FIG. 7 is a cut-away front elevation view of a folding knife with the blade in a partially closed position and a disengaged blade lock mechanism;

FIG. 8 is a cut-away front elevation view of a folding knife with the blade in a partially closed position; and

FIG. 9 is a cut-away front elevation view of a folding knife with the blade in the fully closed position and showing an unlocking mechanism according to an exemplary embodiment.

### DETAILED DESCRIPTION OF PREFERRED EMBODIMENTS

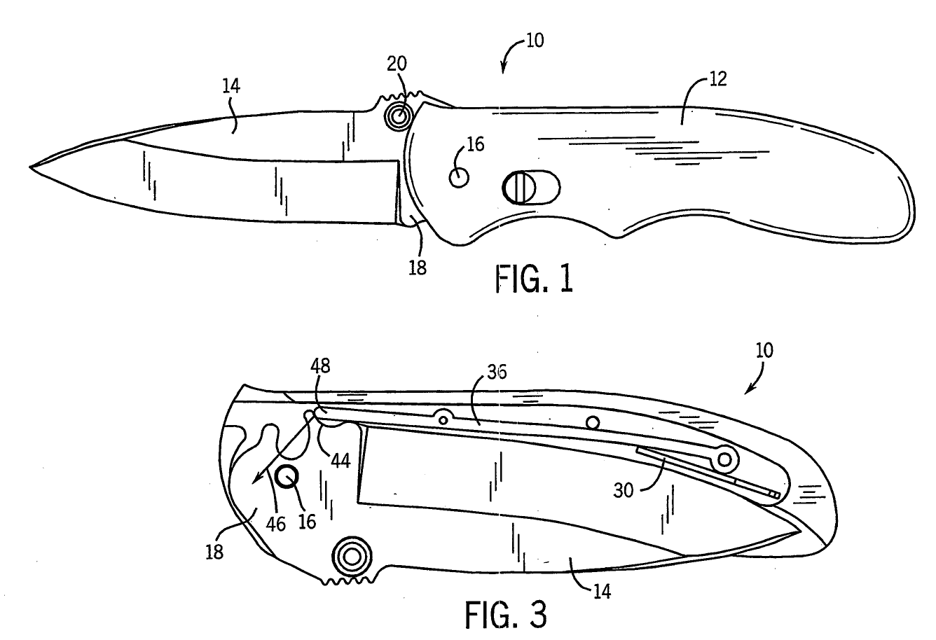

Referring to FIG. 1, a knife, shown as folding knife 10, includes a handle 12 pivotally coupled to an implement, shown as, but not limited to blade 14. The blade 14 is coupled to the handle by a blade axle 16 that extends through a tang 18 of the blade. A thumb stud 20 may extend outwardly from a portion of the blade for gripping by the user.

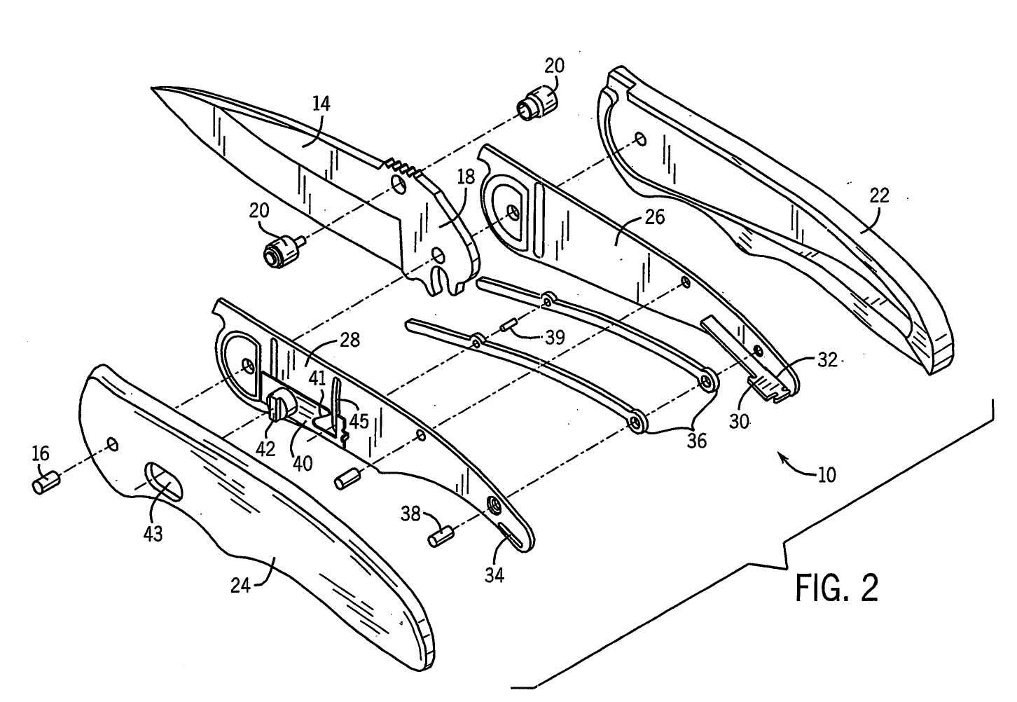

Referring to FIG. 2, in an exemplary embodiment, folding knife 10 is enclosed by a pair of handle sides 22, 24. Liners 26, 28 fit within handle sides 22, 24. A leaf spring 30 is coupled to liners 26, 28 by engaging with slots 32, 34 and liners 26, 28. A spring arm 36, which may comprise one or more pieces, is coupled to liners 26, 28 via pivot axle 38. An unlocking mechanism, shown as unlocking latch 40, may be disposed between handle side 24 and liner 28 and include a knob 42 that extends through an aperture 43 in handle side 24. A rod 39 may extend through spring arm 36 and through a slot 45 in liner 28 such that it may engage unlocking latch 40 during a portion of its travel.

Referring to FIGS. 2 and 3, spring arm 36 is curved in its relaxed position (see FIG. 2) such that it exerts a force against blade 14 when blade 14 is in the closed position shown in FIG. 3. In a preferred embodiment, spring arm 36 is the same width as blade 14 and is installed directly in the plane of blade 14. Blade tang 18 includes a contoured surface 44 that serves as the contact point between tang 18 and a distal end 48 of spring arm 36 when the blade 14 is in the closed position.

Further referring to FIG. 3, due to the angle of contoured surface 44, when blade 14 is fully closed, spring arm 36 exerts a counterclockwise (closing) force on blade 14 as seen by force vector 46, which results from the contact between distal end 48 and contoured surface 44. Accordingly, although a user forces the blade 14 into the closed position against the bias of spring arm 36, once the blade 14 is near the closed position, the interaction between spring arm 36 and contoured surface 44 maintains the blade in the closed position to prevent accidental opening of the blade 14.

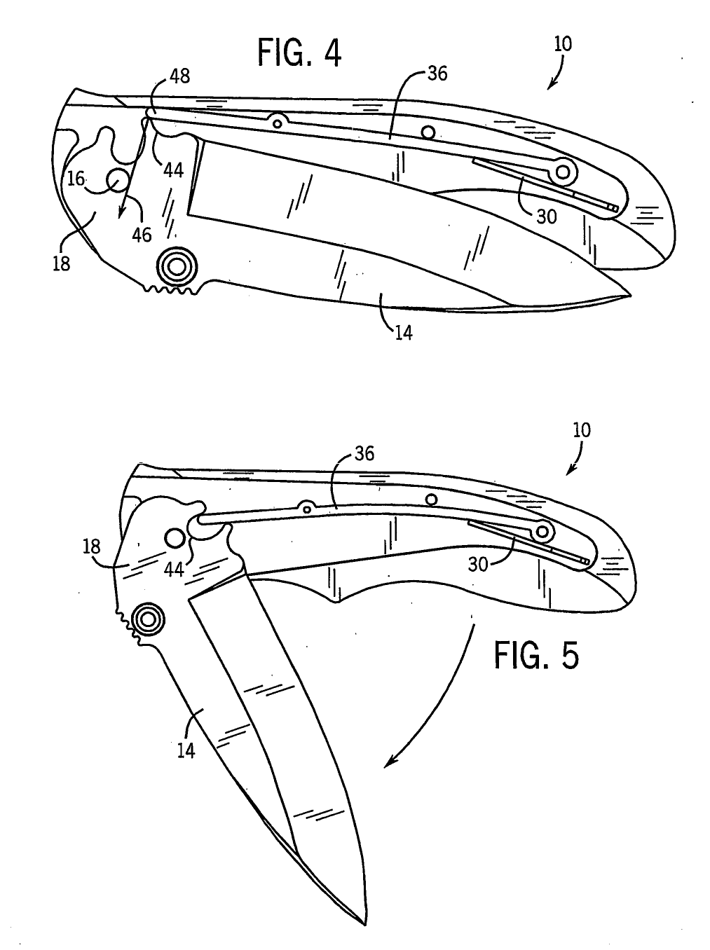

Referring to FIG. 4, as a user manually opens blade 14, distal end 48 rides along contoured surface 44, thus changing the point of tangency and the direction of force vector 46. When force vector 46 crosses to the right-hand side (in the view of FIG. 4) of the centerpoint of blade axle 16, spring arm 36 exerts a clockwise force on blade 14, thus biasing the blade 14 into the open position. In an exemplary embodiment, spring arm 36 exerts an opening force on blade 14 once the blade 14 has been manually opened to a position approximately ten degrees from the fully closed position. The number of degrees the blade 14 must be manually opened prior to receiving assistance from spring arm 36 may be changed by altering contoured surface 44 of tang 18 to achieve the desired effect. Note that in an exemplary embodiment, leaf spring 30 has an insignificant effect on the mechanics detailed in FIGS. 3 and 4.

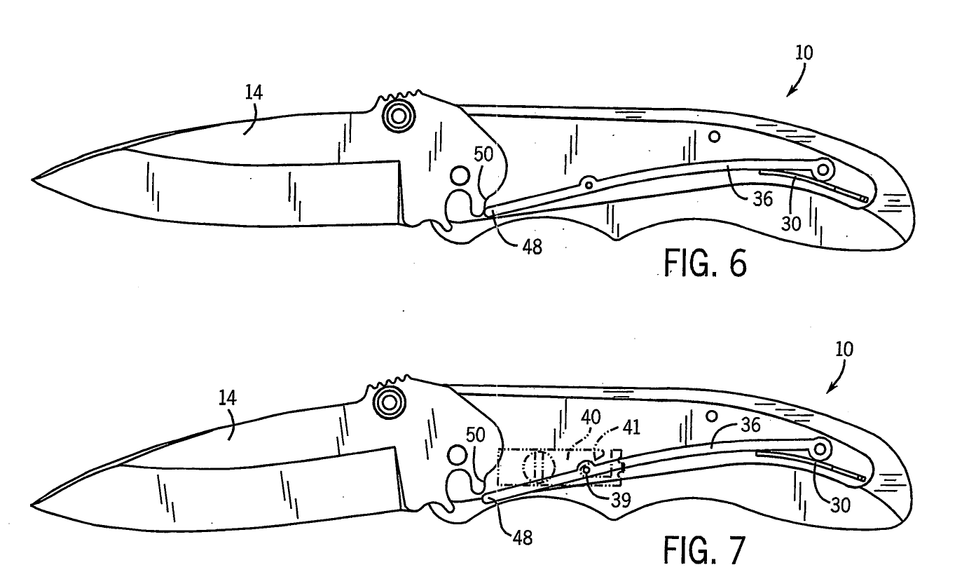

Referring to FIG. 5, spring arm 36 pivots the blade 14 into the fully opened position as it rides along contoured surface 44 of blade tang 18. Ideally, spring arm 36 is configured to drive blade 14 from the position shown in FIG. 4 into the fully opened position of FIG. 6 without further manual intervention by the user.

Referring to FIG. 6, once blade 14 is in the fully opened position, distal end 48 of spring arm 36 locks the blade 14 into the fully open position by wedging behind catch face 50. In this configuration, the blade 14 is prevented from rotating out of the open position. In the embodiment depicted in FIG. 6, leaf spring 30 provides an upward bias on spring arm 36 to ensure distal end 48 maintains its position behind catch face 50, thus maintaining blade 14 in the locked open position. In alternative embodiments, the spring arm 36 may be configured to maintain position behind catch face 50 in other ways.

Referring to FIG. 7, a user must disengage spring arm 36 from the locked position in order to close blade 14. One way of doing so is through the use of unlocking latch 40, which is coupled to spring arm 36 via rod 39 such that when a user slides latch 40 away from blade 14, rod 39 slides down ramp 41, forcing distal end 48 out of engagement with catch face 50, permitting the user to close blade 14. Once the blade 14 is partially moved from the fully opened position, the user may release unlocking latch 40, as distal end 48 will then ride along contoured surface 44 as the blade 14 is closed.

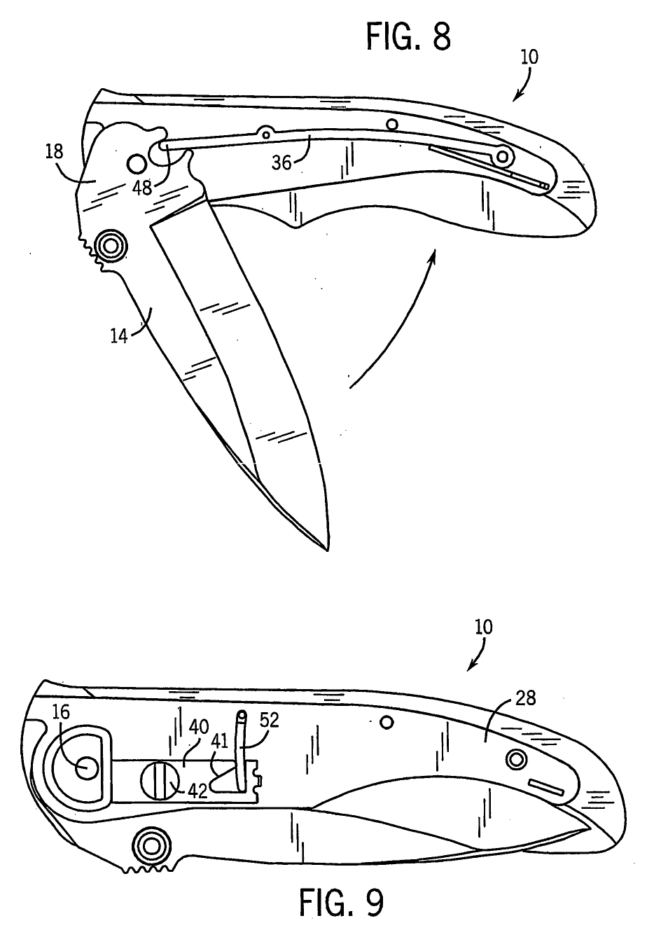

Referring to FIG. 8, as a user closes blade 14, blade tang 18 forces distal end 48 upward (in the reference frame of FIG. 8) against the bias of spring arm 36 until the blade 14 nears the fully closed position and the spring arm 36 begins exerting a counterclockwise force on blade 14, thus moving the blade 14 into the fully closed position (see FIG. 3).

Referring to FIG. 9, in an exemplary embodiment, unlocking latch 40 may be biased toward the blade axle 16 by a spring mechanism 52 such that it automatically slides into its normal use position (not disengaging spring arm 36) when the user is not grasping knob 42. In another embodiment, unlocking latch 40 may be braced into its normal use position by a coil spring (not shown).

The utilization of spring arm 36 directly in the plane of blade 14 and having a width approximately equal to blade 14 rather than disposed out of the plane of the blade permits the folding knife 10 to be less bulky than other designs, which require additional space inside the handle to accommodate the mechanism. Further, because in a preferred embodiment, spring arm 36 also functions as a blade lock, space within handle sides 22, 24 is further efficiently utilized due to the lack of an additional blade lock mechanism.

Many folding knife designs utilize a liner lock that includes a leaf spring disposed parallel to the plane of the blade that springs behind the blade tang when the blade has moved to the fully open position in order to lock the blade in the open position. A liner lock may require additional manufacturing costs because the blade tang may require a secondary grinding process in order to mate properly with the liner lock. Such an additional manufacturing step adds to the cost of a folding knife. The blade lock of the present invention may reduce manufacturing costs due to greater dimensional tolerances for the blade and spring arm locking mechanism.

The unlocking mechanism depicted in FIG. 9 is only one exemplary embodiment. Other unlocking mechanisms may include a swiveling cam or any number of mechanical devices having a pin and guide intended to disengage the spring arm from the blade tang.

The spring arm 36 may be coupled to liners 32, 34 via pivot axle 38. This configuration may be altered depending on the configuration of the folding knife, such as by the use of other attachment mechanisms known in the art to attach the spring arm and handle components.

In an exemplary embodiment, the blade 14 stops rotating in the opening direction when thumb stud 20 engages one or both liners 32, 34. Other ways of preventing over-rotation of the blade are well known in the folding knife art.

The components depicted in FIG. 2 are constructed of materials known in the folding knife art. Typically, the liners 32, 34 are metallic. The spring arm 36 requires a spring temper to maintain the proper bias against the blade to ensure assisted opening functionality and is of the same degree of hardness as the blade in an exemplary embodiment. Leaf spring 30 is of a configuration and material chosen to properly ensure that the spring arm 36 maintains its position against the catch face 50 when locking the blade in the open position.

In an alternative embodiment, the folding knife may be configured to have the assisted opening feature described herein, but not the blade lock mechanism. Instead, the contoured surface of the blade tang may be configured such that the spring arm 36 provides a bias in the opening direction to aid in maintaining the blade in the open position while not requiring the user to manually unlock the spring arm 36.

While the detailed drawings and specific examples given describe various exemplary embodiments of the folding knife, they serve the purpose of illustration only. It is to be understood that the invention is not limited in its application to the details of construction and the arrangements of components set forth in the preceding description or illustrated in the drawings. For example, the folding knife may have multiple blades and may include multiple spring arms configured to assist the opening of those blades and lock the blades into the open position. The space-saving mechanism of the present invention may permit the use of such multiple blades where other folding knives having similar functionality would be too bulky to do so. Rather than a blade, another implement such as a saw may be substituted and have the same functionality. Furthermore, other substitutions, modifications, changes, and omissions may be made in the design, operating conditions, and arrangements of the exemplary embodiments without departing from the scope of the invention as expressed in the appended claims.

What is claimed is:

1. A folding tool, comprising:
a handle;
an implement pivotally coupled to the handle, the implement adapted to travel between a closed position and an open position and having a tang with a contoured surface; and
a spring arm having a first end coupled to the handle and a second end adapted to interact with the implement;
wherein the spring arm both exerts an opening force on the implement during, at least a portion of the travel of the implement between the closed position and the open position and locks the implement into the open position.

2. The folding knife of claim 1, wherein the spring arm exerts the opening force on the implement via contact between the second end and the contoured surface.

3. The folding knife of claim 1, wherein the spring arm locks the implement into the open position via engagement with a portion of the contoured surface.

4. The folding knife of claim 3, wherein the spring arm must be manually disengaged from the portion of the contoured surface prior to rotation of the implement into the closed position.

5. The folding knife of claim 4, further comprising an unlocking mechanism configured to disengage the spring arm from the contoured surface.

6. The folding knife of claim 5, wherein the unlocking mechanism is an unlocking latch.

7. The folding knife of claim 1, further comprising a leaf spring coupled to the handle, the leaf spring adapted to bias the spring arm into a position locking the implement into the open position.

8. The folding knife of claim 1, wherein the spring arm exerts a closing force on the implement when the implement is in the closed position and the opening force on the implement when the implement is rotated several degrees away from the closed position.

9. The folding knife of claim 8, wherein the spring arm exerts the opening force on the implement when the implement is in the open position.

10. The folding knife of claim 9, wherein the implement is a blade.

11. The folding knife of claim 1, wherein the spring arm is in a plane defined by the implement.

12. The folding knife of claim 1, wherein the implement is a knife blade.

13. A folding knife, comprising:
a handle;
a blade pivotally coupled to the handle, the blade having a closed position and an open position and having a tang with a contoured surface; and
a spring located in a plane defined by the blade, the spring having a proximal end coupled to the handle and a distal end adapted to exert a force on the blade via contact with the contoured surface.

14. The folding knife of claim 13, wherein the spring locks the blade in the open position.

15. The folding knife of claim 14, further comprising an unlocking mechanism configured to release the blade from the open position.

16. The folding knife of claim 15, wherein the unlocking mechanism is an unlocking latch.

17. The folding knife of claim 13, wherein the spring exerts a closing force on the blade when the blade is in a first position and the spring exerts an opening force on the blade when the blade is in a second position.

18. The folding knife of claim 17, wherein the first position is any position in the range between the closed position and ten degrees of rotation away from the closed position.

19. The folding knife of claim 18, wherein the second position is any position in the range between the open position and ten degrees of rotation away from the closed position.

20. The folding knife of claim 13, wherein the spring comprises a pair of spring arms, each approximately half the width of the blade.
